(19) United States
(12) Patent Application Publication
(10) Pub. No.: US 2010/0249121 A1
(43) Pub. Date: Sep. 30, 2010

(54) USE OF TETRAMIC ACID DERIVATIVES FOR CONTROLLING VIRUS-TRANSFERRING VECTORS

(76) Inventors: Reiner Fischer, Monheim (DE); Konrad Kemper, Sao Paulo (BR); Jürgen Kühnhold, Bergisch Gladbach (DE); Xavier Alain Marie Van Waetermeulen, Dusseldorf (DE); Francisco Leonel Junior Lozano, Sao Paulo (BR)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/666,834

(22) PCT Filed: Jun. 20, 2008
(86) PCT No.: PCT/EP08/04981

§ 371 Date: Jun. 4, 2010

(30) Foreign Application Priority Data
Jul. 3, 2007 (EP) 07111610.7

(51) Int. Cl. A01N 43/88; A01N 43/36; A01N 43/40; A01N 43/78; A01P 7/04

(52) U.S. Cl. 514/229.2; 514/409; 514/341; 514/357; 514/342; 514/365

(57) ABSTRACT

The present invention relates to the use of tetramic acid derivatives on their own and also of active compound combinations comprising, firstly, known tetramic acid derivatives and, secondly, further known insecticidal active compounds for controlling viroses transferred by insects.

The present invention relates to the use of tetramic acid derivatives on their own and also of active compound combinations comprising, firstly, known tetramic acid derivatives and, secondly, further known insecticidal active compounds for controlling viroses transferred by vectors (insects).

It is already known that certain cyclic ketoenols have herbicidal, insecticidal and acaricidal properties. The activity of these compounds is good; however, it is sometimes unsatisfactory at low application rates.

Known to have insecticidal and/or acaricidal activity are 1H-3-arylyprrolidine-2,4-dione derivatives (WO 98/05638) and their cis isomers (WO 04/007448).

Also known are mixtures of compounds from WO 98/05638 with other insecticides and/or acaricides: WO 01/89300, WO 02/00025, WO 02/05648, WO 02/17715, WO 02/19824, WO 02/30199, WO 02/37963, WO 05/004603, WO 05/053405, WO 06/089665, DE-A-10342673, WO 2008/006516. However, the activity of these mixtures is not always satisfactory.

It has now been found that both the compounds of the formulae (I-1) and (I-2)

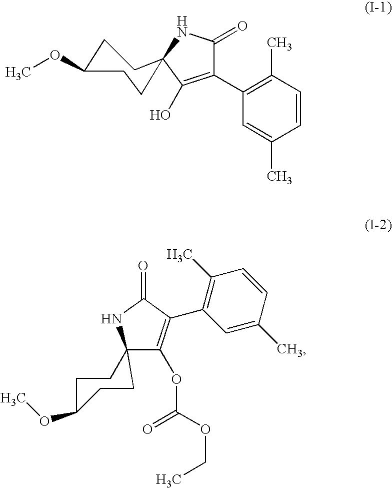

both compounds known from WO 04/007448,
and active compound combinations comprising the compounds (1-1) or (I-2) and at least one agonist or antagonist of acetylcholine receptors, in particular a compound of the formulae below

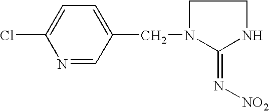

imidacloprid (A1) known from EP-A-00192060
and/or

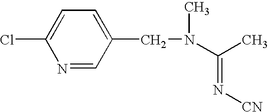

acetamiprid (A2) known from WO 91/04965
and/or

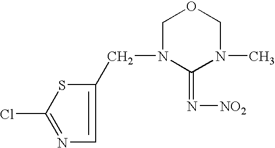

thiamethoxam (A3) known from EP-A-00580553
and/or

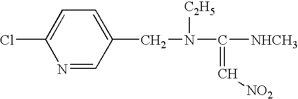

nitenpyram (A4) known from EP-A-00302389
and/or

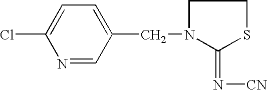

thiacloprid (A5) known from EP-A-00235725
and/or

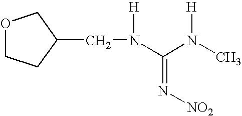

dinotefuran (A6) known from EP-A-00649845
and/or

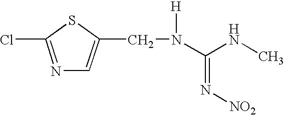

clothianidin (A7) known from EP-A-00376279
and/or

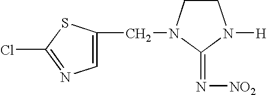

imidaclothiz (A8) known from EP-A-00192060
are particularly suitable for preventing the spreading of viruses in crops such as soya beans, cotton, beet, maize, rice, potatoes, tobacco, cereals, tropical fruit, vegetables and ornamental plants.

Growth-regulating insecticides like the compounds of the formulae (I-1) and (I-2) generally act slowly and have no killing effect on adult animals. Owing to delayed onset of action, their suitability for control of viruses was not expected. It is completely surprising that, in spite of the delayed onset of action, the compounds of the formulae (I-1) and (I-2) are suitable for the control of viruses by controlling the virus-transferring vectors. Virus-transferring vectors are to be understood as meaning insects, such as, for example, white flies, leaf hoppers, thrips, spider mites and aphids, which transfer phytopathogenic viruses.

It is furthermore surprising that the effect of the active compound combinations on the spreading of the viruses is considerably higher than the sum of the effects of the individual active compounds. An unforeseeable true synergistic effect is present, and not just an addition of activities.

Preference is given to active compound combinations comprising the compound of the formula (I-1) and at least one active compound from the group of the agonists or antagonists of acetylcholine receptors.

Preference is likewise given to active compound combinations comprising the compound of the formula (I-2) and at least one active compound from the group of the agonists or antagonists of acetylcholine receptors.

Of particular interest are the following combinations: (I-1)+(A1), (I-1)+(A2), (I-1)+(A3), (I-1)+(A4), (I-1)+(A5), (I-1)+(A6), (I-1)+(A7), (I-1)+(A8), (I-2)+(A1), (I-2)+(A2), (I-2)+(A3), (I-2)+(A4), (I-2)+(A5), (I-2)+(A6), (I-2)+(A7), (I-2)+(A8).

The active compound combinations may additionally also comprise further fungicidally, acaricidally or insecticidally effective added components.

The improved activity is particularly pronounced when the active compounds in the active compound combinations are present in certain weight ratios. However, the weight ratios of the active compounds in the active compound combinations can be varied within a relatively wide range. In general, the combinations according to the invention comprise the active compound of the formula (I-1) or (I-2) and the mixing partner in the preferred and particularly preferred mixing ratios stated in the table below:
the mixing ratios are based on weight ratios. The ratio is to be understood as meaning active compound of the formula (I-1):mixing partner or formula (I-2):mixing partner

| | | Particularly | Very particularly |
|---|---|---|---|
| | Preferred mixing | preferred | preferred mixing |
| Mixing partner | ratio | mixing ratio | ratio |
| imidacloprid | 25:1 to 1:25 | 5:1 to 1:5 | 3:1 to 1:3 |
| acetamiprid | 25:1 to 1:25 | 5:1 to 1:5 | 3:1 to 1:3 |
| thiamethoxam | 25:1 to 1:25 | 5:1 to 1:5 | 3:1 to 1:3 |
| nitenpyram | 25:1 to 1:25 | 5:1 to 1:5 | 3:1 to 1:3 |
| thiacloprid | 25:1 to 1:25 | 5:1 to 1:5 | 3:1 to 1:3 |
| dinotefuran | 25:1 to 1:25 | 5:1 to 1:5 | 3:1 to 1:3 |
| clothianidin | 25:1 to 1:25 | 5:1 to 1:5 | 3:1 to 1:3 |
| imidaclothiz | 25:1 to 1:25 | 5:1 to 1:5 | 3:1 to 1:3 |

The active compound combinations, and also the compounds of the formulae (I-1) and (I-2) on their own, are suitable for preventing the spreading of viruses in soya beans, maize, rice, beets, cereals (wheat, barley, rye, oats, triticale), tobacco, cotton, vegetables, tropical fruit, potatoes and ornamental plants, and they are tolerated well by plants and have favourable homeotherm toxicity.

Preferred are plant viruses having a circular single-strand DNA, so-called Gemini viruses, such as, for example, Bean Golden Mosaic Virus (BGMV), Cassaya Latend Virus (CLV), Tomato Golden Mosaic Virus (TGMV), Maize Streak Virus (MSV), Tomato Spotted Wilt Virus (TSWV), Tobacco Mosaic Virus (TMV), Tomato Mosaic Virus (ToMV), Potato Yellow Mosaic Virus (PYMV), Tomato Yellow Leaf Curl Virus (TYLCV), Barley Yellow Dwarf Virus (BYDV), Beet Mosaic Virus (BtMV), Beet Yellow Virus (BYV), Beet Western Yellow Virus (BWYV).

The crops to be protected, which have only been described in a general manner, are described in a more differentiated and more specific manner below. Thus, with respect to the use, vegetable is to be understood as meaning, for example, fruit vegetable and flower-heads/curds as vegetables, for example bell peppers, chilli peppers, tomatoes, aubergines, cucumbers, cucurbits, courgettes, broad beans, runner beans, bush beans, peas, artichokes, maize;

but also leafy vegetables, for example lettuce, chicory, endives, cress, rocket salad, field salad, iceberg lettuce, leek, spinach, Swiss chard;
furthermore tuber vegetables, root vegetables and stem vegetables, for example celeriac, beetroot, carrots, garden radish, horseradish, scorzonera, asparagus, table beet, palm shoots, bamboo shoots, moreover bulb vegetables, for example onions, leek, fennel, garlic;
furthermore brassica vegetables, such as cauliflowers, broccoli, kohlrabi, red cabbage, white cabbage, green cabbage, Savoy cabbage, Brussels sprouts, Chinese cabbage.

Thus, with respect to the use in cereal crops, cereal is to be understood as meaning, for example, wheat, barley, rye, oats, triticale but also maize, millet and rice;

furthermore grapevine and tropical crops, such as, for example, mangoes, papayas, figs, pineapples, dates, bananas, durians, kakis, coconuts, cacao, coffee, avocados, litchis, maracuj as, guavas,
moreover almonds and nuts, such as, for example, hazelnuts, walnuts, pistachios, cashew nuts, brazil nuts, pecan nuts, butter nuts, chestnuts, hickory nuts, macadamia nuts, peanuts,
additionally also soft fruit, such as, for example, blackcurrants, gooseberries, raspberries, blackberries, blueberries, strawberries, red bilberries, kiwis, cranberries.

With respect to the use, ornamental plants are to be understood as meaning annual and perennial plants, for example cut flowers, such as, for example, roses, carnations, gerbera, lilies, marguerites, chrysanthemums, tulips, daffodils, anemones, poppies, amaryllis, dahlias, azaleas, malves, but also, for example, bedding plants, potted plants and shrubs, such as, for example, roses, tagetes, pansies, geraniums, fuchsias, hibiscus, chrysanthemums, busy lizzies, cyclamen, African violets, sunflowers, begonias,

furthermore, for example, bushes and conifers, such as, for example, fig trees, rhododendron, spruce trees, fir trees, pine trees, yew trees, juniper trees, stone pines, rose-bays.

All plants and plant parts can be treated in accordance with the invention. In this context, plants are understood as meaning all plants and plant populations such as desired and undesired wild plants or crop plants (including naturally occurring crop plants). Crop plants can be plants which can be obtained by traditional breeding and optimization methods or by biotechnological and recombinant methods, or combinations of these methods, including the transgenic plants and including the plant varieties which are capable or not capable of being protected by Plant Breeders' Rights. Plant parts are understood as meaning all aerial and subterranean parts and organs of the plants such as shoot, leaf, flower and root, examples which may be mentioned being leaves, needles, stalks, stems, flowers, fruit bodies, fruits and seeds, but also roots, tubers and rhizomes. The plant parts also include crop material and vegetative and generative propagation material, for example cuttings, tubers, rhizomes, slips and seeds.

The treatment according to the invention with the active compound, of the plants and plant parts, is effected directly or by treating their environment, habitat or store using conventional treatment methods, for example by dipping, spraying, fumigating, fogging, scattering, brushing on, injecting, and, in the case of propagation material, in particular seeds, furthermore by coating with one or more coats.

As already mentioned above, all plants and their parts can be treated in accordance with the invention. In a preferred embodiment, plant species and plant varieties which are found in the wild or which are obtained by traditional biological breeding methods, such as hybridization or protoplast fusion, and parts of these species and varieties are treated. In a further preferred embodiment, transgenic plants and plant varieties which are obtained by recombinant methods, if appropriate in combination with traditional methods (genetically modified organisms) and their parts are treated. The terms “parts”, “parts of plants” or “plant parts” are described above.

Plants which are especially preferably treated in accordance with the invention are those of the varieties which are in each case commercially available or in use. Plant varieties are understood as meaning plants with novel traits which have been bred both by conventional breeding, by mutagenesis or by recombinant DNA techniques. They may take the form of varieties, biotypes or genotypes.

Depending on the plant species or plant varieties, their location and growth conditions (soils, climate, vegetation period, nutrition), superadditive (“synergistic”) effects may also occur as a result of the treatment according to the invention. Effects which exceed the effects actually to be expected are, for example, reduced application rates and/or widened activity spectrum and/or an enhancement of the activity of the substances and compositions which can be used in accordance with the invention, better plant growth, increased tolerance to high or low temperatures, increased tolerance to drought or to water or soil salinity, increased flowering performance, facilitated harvest, speedier maturation, higher yields, higher quality and/or higher nutritional value of the crop products, better storability and/or processability of the crop products.

The preferred transgenic plants or plant varieties (plants or plant varieties obtained by means of genetic engineering) which are to be treated in accordance with the invention include all plants which, by means of the recombinant modification, have received genetic material which confers particularly advantageous valuable traits to these plants. Examples of such traits are better plant growth, increased tolerance to high or low temperatures, increased tolerance to drought or to water or soil salinity, increased flowering performance, facilitated harvest, speedier maturation, higher yields, higher quality and/or higher nutritional value of the crop products, better storability and/or processability of the crop products. Other examples of such traits which are particularly emphasized are an improved defence of the plants against animal and microbial pests such as insects, mites, phytopathogenic fungi, bacteria and/or viruses, and an increased tolerance of the plants to specific herbicidal active compounds. Examples of transgenic plants which are mentioned are the important crop plants such as cereals (wheat, rice), maize, soybean, potato, cotton, tobacco, oilseed rape and fruit plants (with the fruits apples, pears, citrus fruits and grapes), with particular emphasis on maize, soybean, potatoes, cotton, tobacco and oilseed rape. Traits which are particularly emphasized are the increased defence of the plants against insects, arachnids, nematodes and slugs and snails as the result of toxins formed in the plants, in particular toxins which are produced in the plants by the genetic material of Bacillus thuringiensis (for example by the genes CryIA(a), CryIA(b), CryIA(c), CryIIA, CryIIIA, CryIIIB2, Cry9c, Cry2Ab, Cry3Bb and CryIF and their combinations) (hereinbelow “Bt plants”). Traits which are also particularly emphasized are the increased defence of plants against fungi, bacteria and viruses by systemic acquired resistance (SAR), systemin, phytoalexins, elicitors and resistance genes and correspondingly expressed proteins and toxins. Traits which are furthermore especially emphasized are the increased tolerance of the plants to specific herbicidal active compounds, for example imidazolinones, sulphonylureas, glyphosate or phosphinotricin (for example “PAT” gene). The specific genes which confer the desired traits can also occur in combinations with one another in the transgenic plants. Examples of “Bt plants” which may be mentioned are maize varieties, cotton varieties, soybean varieties and potato varieties sold under the trade names YIELD GARD® (for example maize, cotton, soybean), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soybean varieties which are sold under the trade names Roundup Ready® (glyphosate tolerance, for example maize, cotton, soybean), Liberty Link® (phosphinotricin tolerance, for example oilseed rape), (imidazolinone tolerance) and STS® (sulphonylurea tolerance, for example maize). Herbicide-resistant plants (bred conventionally for herbicide tolerance) which may also be mentioned are the varieties sold under the name Clearfield® (for example maize). Naturally, what has been said also applies to plant varieties which will be developed, or marketed, in the future and which have these genetic traits or traits to be developed in the future.

The active compound combinations or the active compounds (1-1) and (I-2) can be converted into the customary formulations, such as solutions, emulsions, wettable powders, suspensions, powders, dusts, pastes, soluble powders, granules, suspoemulsion concentrates, natural and synthetic materials impregnated with active compound, and ultrafine encapsulations in polymeric materials.

These formulations are produced in the known manner, for example by mixing the active compound with extenders, that is, liquid solvents and/or solid carriers, optionally with the use of surfactants, that is, emulsifiers and/or dispersants and/or foam-formers.

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulphones and sulphoxides (such as dimethyl sulphoxide).

If the extender used is water, it is also possible to use, for example, organic solvents as auxiliary solvents. Suitable liquid solvents are essentially: aromatics, such as xylene, toluene or alkylnaphthalenes, chlorinated aromatics and chlorinated aliphatic hydrocarbons, such as chlorobenzenes, chloroethylenes or methylene chloride, aliphatic hydrocarbons, such as cyclohexane or paraffins, for example petroleum fractions, mineral and vegetable oils, alcohols, such as butanol or glycol, and also their ethers and esters, ketones, such as acetone, methyl ethyl ketone, methyl isobutyl ketone or cyclohexanone, strongly polar solvents, such as dimethylformamide and dimethyl sulphoxide, and also water.

Suitable solid carriers are:

for example ammonium salts and ground natural minerals, such as kaolins, clays, talc, chalk, quartz, attapulgite, montmorillonite or diatomaceous earth, and ground synthetic minerals, such as finely divided silica, alumina and silicates, suitable solid carriers for granules are: for example crushed and fractionated natural rocks such as calcite, marble, pumice, sepiolite and dolomite, and also synthetic granules of inorganic and organic meals, and granules of organic material such as sawdust, coconut shells, maize cobs and tobacco stalks; suitable emulsifiers and/or foam-formers are: for example non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and protein hydrolysates; suitable dispersants are: for example lignosulphite waste liquors and methylcellulose.

Tackifiers such as carboxymethylcellulose and natural and synthetic polymers in the form of powders, granules or latices, such as gum arabic, polyvinyl alcohol and polyvinyl acetate, and also natural phospholipids, such as cephalins and lecithins, and synthetic phospholipids, can be used in the formulations. Other possible additives are mineral and vegetable oils.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95% by weight of active compound, preferably between 0.5 and 90%, and in addition preferably extenders and/or surfactants.

The active compound content of the use forms prepared from the commercial formulations may vary within wide limits. The active compound concentration of the use forms may be from 0.0000001 to 95% by weight of active compound, preferably between 0.0001 and 1% by weight.

Application is carried out in a customary manner adapted to the use forms.

### USE EXAMPLES

### Example 1

In three replications, plots of a size of 7.5 m² with tomatoes of the cultivar “Jumbo” are treated against the virus-transferring vector Bemisia argentifolii. Application is carried out using a motor-operated knapsack sprayer. The active compound example (I-2) (240 SC) in a tank mix with 0.186% a.i. soya oil Natur'L Oleo (OL 930) and the commercial standard imidacloprid (200 SC) are applied at the stated application rates. Four applications are carried out at intervals of in each case 7 days using a water application rate of in each case 300 l, 300 l, 500 l and 600 l/ha.

Evaluation is carried out 25 days after the 4th treatment by scoring the virus infestation with the Tomato Yellow Leaf Curl Virus (TYLCV) on the plants.

| | | Degree of control according |
|---|---|---|
| | Application rate | to Abbott (%) |
| Active compound | g of a.i./ha | 25 d |
| imidacloprid | 72 | 40.0 |
| Example (I-2) | 24 | 74.3 |

In the control, 11.7 of 15 plants were infected by the TYLCV.

### Example 2

In three replications, plots of a size of 7.5 m² with tomatoes of the cultivar “Jumbo” are treated against the virus-transferring vector Bemisia argentifolii. Application is carried out using a pressurized air-operated knapsack sprayer. The active compound example (I-2) (240 SC) in a tank mix with 0.186% a.i. soya oil Natur'L Oleo (OL 930) and the commercial standard imidacloprid (200 SC) are applied at the stated application rates. Three applications are carried out at intervals of in each case 7 days. The water application rates are 300 l/ha, 400 l/ha and 600 l/ha.

Evaluation is carried out 14 days after the 3rd treatment by scoring the virus infestation with the Tomato Yellow Leaf Curl Virus (TYLCV) on the plants.

| | | Degree of control according |
|---|---|---|
| | Application rate | to Abbott (%) |
| Active compound | g of a.i./ha | 14 d |
| imidacloprid | 72 | 33 |
| Example (I-2) | 48 | 83 |

All 18 plants in the control were infected by the TYLCV.

### Example 3

In three replications, plots of a size of 12 m² with bush beans of the cultivar “Carioca” are treated against the virus-transferring vector Bemisia argentifolii. Application is carried out using a pressurized air-operated knapsack sprayer. The active compound example (I-2) (240 SC) in a tank mix with 0.186% a.i. soya oil Natur'L Oleo (OL 930) and the commercial standard imidacloprid (200 SC) are applied at the stated application rates. Three applications are carried out at intervals of in each case 7 days. The water application rate is in each case 300 l/ha.

Evaluation is carried out 16 days after the first treatment by scoring the virus infestation with the Bean Golden Mosaic Virus (BGMV) on the plants.

| | | Degree of control according to |
|---|---|---|
| | Application rate | Abbott (%) |
| Active compound | g of a.i./ha | 16 d |
| imidacloprid | 72 | 60.0 |
| Example (I-2) | 48 | 70.0 |

All 10 plants in the control were infected by the BGMV.

According to the invention, it is also possible to treat the plants listed particularly advantageously with the active compound mixture. The preferred ranges given above for the mixtures also apply to the treatment of these plants. Particular emphasis is given to the treatment of the plants with the mixtures specifically listed in the present text.

The good activity of the active compound combinations in the control of virus-transferring vectors is illustrated by the examples below. Whereas the individual active compounds have weaknesses in their activity, the combinations have an activity which exceeds a simple addition of activities.

For different active compounds, a synergistic effect is always present when the activity of the active compound combinations is greater than the sum of the activities of the active compounds applied individually.

The expected activity for a given combination of two active compounds can be calculated according to S. R. Colby, Weeds 15 (1967), 20-22 as follows:

If
X is the degree of control, expressed in % of the untreated control, when using the active compound A at an application rate of m g/ha or in a concentration of m ppm,
Y is the degree of control, expressed in % of the untreated control, when using the active compound B at an application rate of n g/ha or in a concentration of n ppm and
E is the degree of control, expressed in % of the untreated control, when using the active compounds A and B at application rates of m and n g/ha or in a concentration of m and n ppm,
   then

$$E = X + Y - \frac{X \cdot Y}{100}$$

If the actual degree of control is greater than the calculated degree of control, the control of the combination is superadditive, i.e. a synergistic effect is present. In this case, the degree of control actually observed must be greater than the value for the expected kill rate (E) calculated using the formula given above.

After the desired period of time, the control in % is determined. 100% means that no plants have been infected by viruses; 0% means that all plants have been infected by viruses.

### Example 4

In three replications, plots of a size of 7.5 m² with tomatoes of the cultivar “Jumbo” are treated against the virus-transferring vector Bemisia argentifolii using a compressed air-operated sprayer. A tank mix of the active compound (I-2) (SC 240) and imidacloprid (SC 200) compared to the active compound (I-2) (SC 240) on its own at the stated application rates using 0.186% a.i. of soya oil (Natur'L Oleo) (OL 930) as tank mix and imidacloprid (SC 200) on its own are applied. Four applications are carried out at intervals of in each case 7 days using a water application rate of in each case 300 l/ha, 300 l/ha, 500 l/ha and 600 l/ha. Evaluation is carried out 25 days after the treatment by scoring the virus infection with the Tomato Spotted Wilt Virus (TSWV) on the plants.

| | | Degree of control according |
|---|---|---|
| | Application rate g | to Abbott (%) |
| Active compound | of a.i./ha | 25 d |
| imidacloprid | 72 | 80 |
| active compound (I-2) | 24 | 10 |
| imidacloprid + | 72 + 24 | 90 |
| active compound (I-2) | | |
| calculated according to | | 82 |
| Colby: | | |

In the control, 3.3 of 15 plants were infected by the TSWV.

1. A method for controlling viruses transferred by insects, comprising applying a compound of the formula (I-1) or (I-2) 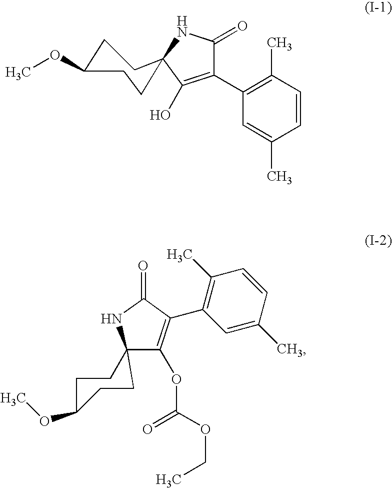
to a plant, plant part, it's habitat, environment, store, or combinations thereof.

2. The method according to claim 1, wherein the compound is of the formula (I-1).

3. The method according to claim 1, wherein the compound is of the formula (I-2).

4. A method for controlling viruses transferred by insects, comprising applying one or more active compound combinations, comprising a compound of the formula (I-1) or (I-2) 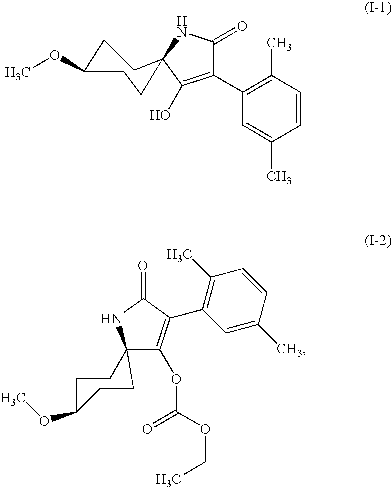
and at least one agonist or antagonist of an acetylcholine receptor to a plant, plant part, it's habitat, environment, store or combinations thereof.

5. The method according to claim 4, wherein the agonist or antagonist of the acetylcholine receptor is selected from the group consisting of:

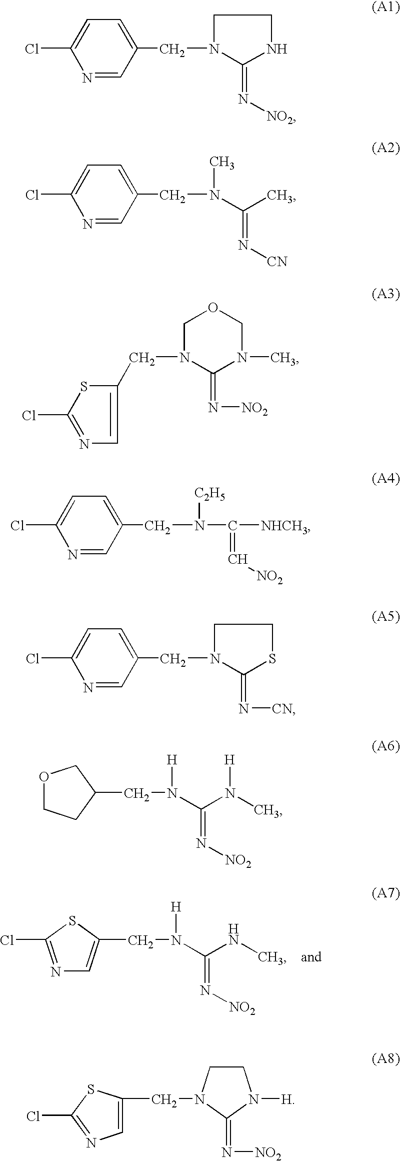

6. The method according to claim 1, wherein the compound of formula (I-1) or (I-2) is applied to soya beans, cotton, beet, maize, rice, potatoes, tobacco, cereals, tropical fruit, vegetables or an ornamental plant.

7. The method according to claim 6, wherein the compound of formula (I-1) or (I-2) is applied to vegetables.

8. The method according to claim 1, wherein the insects are white flies.

9. The method according to claim 4, wherein the one or more active compound combinations is applied to soya beans, cotton, beet, maize, rice, potatoes, tobacco, cereals, tropical fruit, vegetables or an ornamental plant.

10. The method according to claim 9, wherein the one or more active compound combinations is applied to vegetables.

11. The method according to claim 4, wherein the insects are white flies.
